(19) United States
(12) Patent Application Publication
(10) Pub. No.: US 2017/0006777 A1
(43) Pub. Date: Jan. 12, 2017

(54) MOWER DECK

(71) Applicant: James Scott Schucker, Gilbertsville, KY (US)

(72) Inventor: James Scott Schucker, Gilbertsville, KY (US)

(21) Appl. No.: 15/084,123

(22) Filed: Mar. 29, 2016

Related U.S. Application Data
(60) Provisional application No. 62/190,086, filed on Jul. 8, 2015.

(51) Int. Cl. A01D 34/81

(52) U.S. Cl. CPC A01D 34/81; A01D 2101/00

(57) ABSTRACT

This is a mower deck housing comprising a body having a top and a peripheral angled skirt wrapping around each blade contained under the deck. Said skirt in the form of a cone where the top of the cone is smaller than the bottom thereby angling the cut grass both downward and outward away from the blades yet in close proximity to enclose the blade at a small distance. Said mower deck adapted to be moved in a longitudinal direction along the ground with said skirt. There can be one or more blades disposed beneath said top and within said skirt and rotatable about a generally vertical axes to define cutting areas, with no discharge opening in said body thereby creating a safe environment outside of the deck. The mower deck can include a wing deck where the blade can be stopped by an arm coming into contact with a belt and pressing it against a pulley.

### CROSS REFERENCE TO RELATED APPLICATIONS

This application claims the benefit of U.S. Provisional Application Ser. No. 62/190,086 filed by James Schucker on Jul. 8, 2015 and entitled “Mower Deck,” which is incorporated herein by reference.

### FIELD OF INVENTION

The field of the invention pertains to engine driven lawn mowers.

### BACKGROUND OF THE INVENTION

Known conventional mowers suffer from dangerous mower decks due to discharging the grass and objects hit to one side. Therefore mowers have been required to cover the side discharge with a chute to direct the discharge in a downward direction so as to deflect objects hit from doing damage. Many chutes are bolted onto the deck to meet this law and It is a dangerous practice to remove the discharge chute but most people take them off because they cause the grass to make an unsightly windrow and are also often in the way not allowing them to trim on one side of the machine. The present invention addresses this issue by not needing one allowing trimming on both sides of the machine and additionally creating a safer environment.

The present invention has no side discharge chute for the user to remove, and moreover it discharges the grass into an open groove that it creates in the grass so that there is minimal unsightly windrowing.

Many companies have created mulching mowers which are similar yet this not a mulcher as it does not try to re-cut the grass to a fine state before returning it back into the cut grass area; though to a limited extent it does do some mulching. This deck design is very efficient using little horsepower as opposed to mulchers that require a lot of horsepower because this design does not try to cut the grass multiple times before dispersing the clippings back into the grass.

Many municipalities now require that grass cuttings be disposed of in an environmentally responsible manner. Frequently, this means that the homeowner must either pay additional sums to have the clippings bagged and removed from their site or dispose of them on their own. One solution has been to use a mulching mower deck that cuts and re-cuts the grass clippings and then drive them down into the grass. In that way, there are no clippings to be collected and disposed. The problem with the present design of mulching mowers is that when the grass gets damp or heavy, the deck cannot get rid of the grass fast enough and ends up clogging between the blade and deck causing a draw of power from the engine even to the point of stalling and also ends up leaving a mess of both clumped clippings and uncut grass.

This mower deck design virtually eliminates this problem. After much search we have found no lawn mowers using or patents relating to a coned shaped skirt. Presently all skirts are vertical at the blade level.

The problem is well described in patent number U.S. Pat. No. 6,681,553 B2 “Mower cutting chamber” by John Deere Corporation yet their skirts are still vertical and their attempt is for even distribution behind the deck laying the clippings on top as opposed to this invention of driving the clippings downward, outward and into the grass to make the clippings relatively disappear.

From: U.S. Pat. No. 6,330,783 B2 (In rotary mowers, grass clippings tend to collect under the deck unless an efficient system is employed to discharge them. Typically, rear dispersal of clippings leaves windrows behind the mower which is objectionable in appearance.) This present design creates a groove in the grass and deposits the cut grass into it, after which the groove closes upon the cut clippings making the clippings appear to disappear, greatly diminishing the windrow effect. When there is more grass than the groove can allow, the clippings are dispersed evenly without windrows.

Engine powered safety mower with self cleaning deck U.S. Pat. No. 5,086,614 A Note that this claims a down discharge yet still uses a 90 degree vertical angled skirt.

Mower baffle system U.S. Pat. No. 8,171,709 B1 (Side discharge mower decks, however, can be problematic when the grass clippings are not sufficiently discharged or directed to the side discharge opening of the mower deck. This can lead to clumping or aggregation of grass clippings on the ground and/or buildup of grass clippings on the underside of the mower deck. Accordingly, there is still a need for a side discharge mower deck that can sufficiently direct and discharge grass clippings.) This design addresses this issue without the need for a side discharge opening as it opens a groove in the grass and leaves the cut clippings there.

### SUMMARY OF THE INVENTION

Broadly described, the present invention includes a mower deck housing comprising a body having a top and a peripheral angled skirt wrapping around each blade contained under the deck. Said skirt in the form of a cone where the top of the cone is smaller than the bottom thereby angling the cut grass both downward and outward away from the blades yet in close proximity to enclose the blade at a small distance. Said mower deck adapted to be moved in a longitudinal direction along the ground with said skirt. There may be one or more blades disposed beneath said top and within said skirt and rotatable about a generally vertical axes to define cutting areas, with no discharge opening in said body thereby creating a safe environment outside of the deck.

When more than a single blade is utilized in the deck, each blade is to have its own skirt and where the skirts come together around the blades a section of the skirt to be cut out where they interfere with each other and then welded together to effectively strengthen the deck structurally and allow the blades to be in close proximity to each other. Note that vertical skirts give little structural strength to the deck. Optimal skirt angle is generally considered to be between 100 and 150 degrees.

When more than one deck is involved as a deck with hinged wing decks a section of the skirt to be cut out where they interfere with each other allowing for close proximity of the blades between decks. The opening between the decks can be covered by flexible material such as rubber to safely contain dangerous debris.

### BRIEF DESCRIPTION OF DRAWINGS

FIG. 1 displays a side view cross section describing how angled skirt around a mower works with air flow and subsequent grass discharge 20 with a pulley drive 220.

FIG. 2 displays a perspective view with an engine drive 230 and wheels 300.

FIG. 3 displays a perspective view of a 3 bladed main deck, without a top plate for visibility, and 2 single bladed wing decks, also displayed without a top plate, wings attached to a main deck with hinges.

FIG. 4 displays a wing deck with belt tensioner, blade brake and belt guides.

### DETAILED DESCRIPTION OF THE INVENTION

The device 100 sometimes called a mower deck assembly is a circular skirt 120 with a horizontal top 110. The angle 25 of the skirt is between 100 and 150 degrees from the inside of the top. Airflow 20 around the skirt 120 causes the grass 10 to part. When the blade 200 cuts the grass 10, the grass clippings 30 fall into the groove 30 caused by the air flow 20.

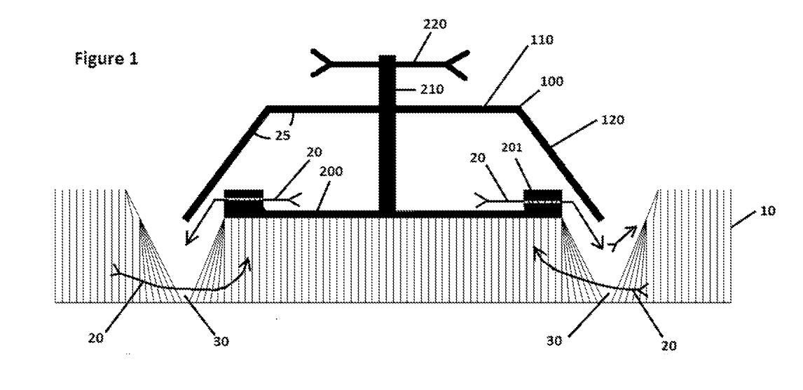

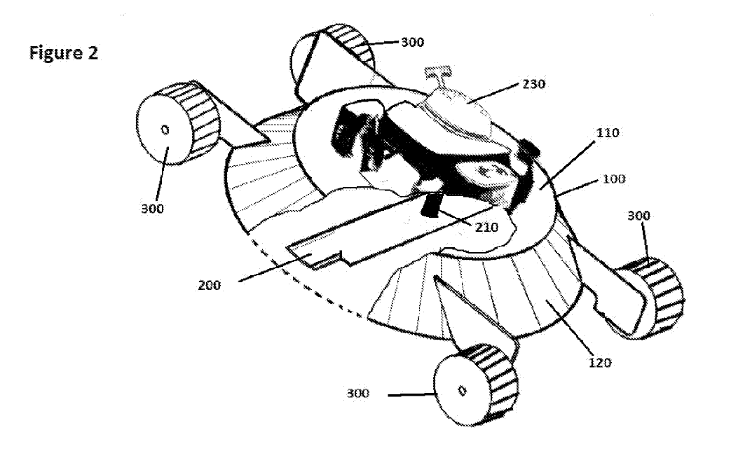

The device 100 may be used with an engine 230 (see FIG. 2) or driven by pulleys 220 (see FIG. 1) to drive the shaft 210 that spins the blades 200 which cut the grass. The device is suspended by attached wheels 300 that contact the ground at a user determined distance.

The blade 200 design works best when the lift tab 201 (see FIGS. 1 & 4) is bent up vertically as the object of the device design is to get the cut grass clippings to flow horizontally out against the skirt 120 and subsequently deflected down into the grass 10, rather than up to the top of the deck as most blades are designed to do but this is not a requirement.

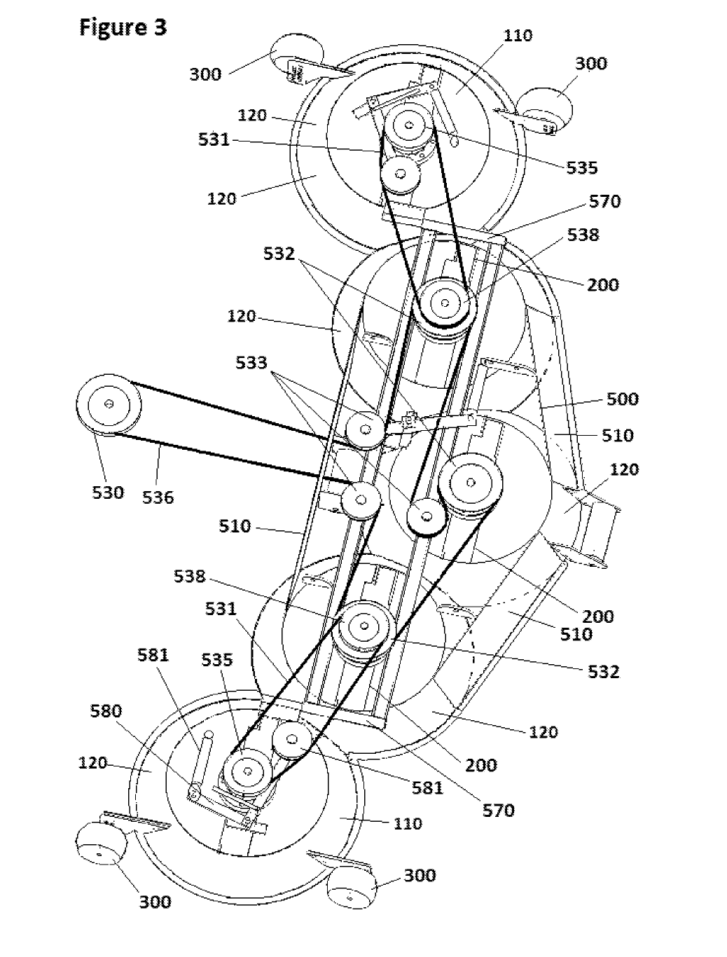

The device can be used in multiple numbers including three skirts 120 under a main deck 500. The main deck 500 is generally triangular so that one skirt 120 can be the lead skirt with two trailing skirts on either side. Tabs 510 are bent down from the top of the main deck 500 to mate with the skirts 120 and are welded together creating an extremely strong deck assembly. On either side of the main deck 500 (see FIG. 3) additional wing decks with skirt 120 with horizontal tops 110 and two wheels 300 may be attached.

Displayed in FIG. 3 the main deck 510 blades 200 are driven with a single main deck belt 536 and the wing deck 520 with its blades 202 are each driven with a wing belt 531 connected to the outer spindles 538 of the main deck 510. The wing deck 520 hinges 570 allows the wing decks 520 to go down and up over 90 degrees. The main deck belt 536 is configured in such a way as to require only 3 idler pulleys 533 to guide the belt 536 from the engine driven pulley 530 across the 3 blade spindles 532.

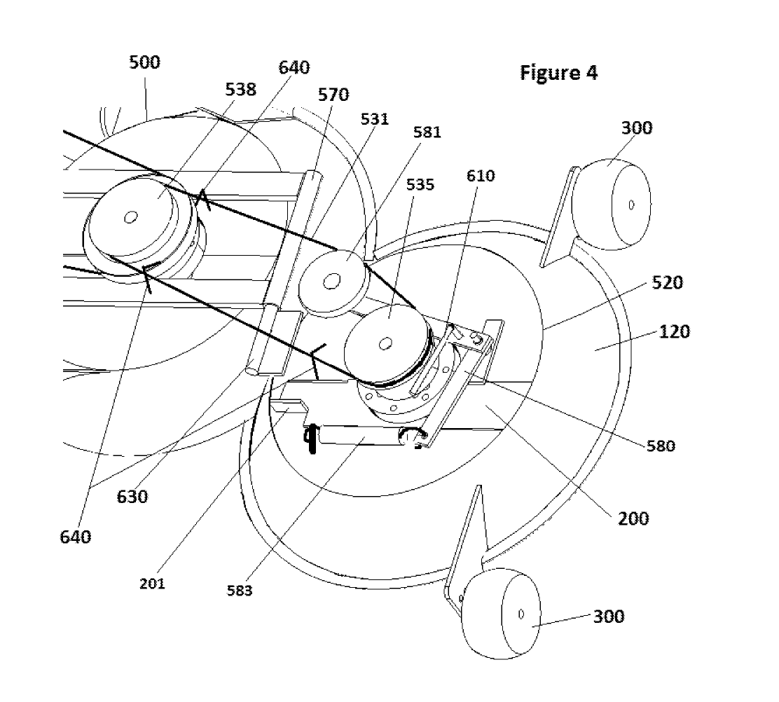

A wing belt tension mechanism 580 is displayed in FIG. 4 that utilizes a spring 581 that tensions the wing belts 531. The wing decks 520 guided by the wheels 300 are allowed to go down and when they go up over 30 degrees they brake the wing blade 200 to a stop as well as keep the wing belt 531 on the pulleys 535 & 538. The wing decks 520 have guide wheels 300 that are used to adjust the cutting height of the grass 10.

Displayed in FIG. 4 is a mechanism to both tension the wing belt 531 and brake the wing blade 200 to a stop. Driving the wing deck 520 is a wing belt 531. The wing belt is tensioned with a pulley 581 on an idler arm 580 with an arm attached 610 used to brake the blade 200 to a stop by contacting the belt 531 and pressing it against the pulley 535. This is done when the wing deck is raised beyond 30 degrees. A spring 583 is used to provide tension to the belt as the wing deck rides up and down. Belt guides 640 are strategically placed to help keep the wing belt 531 on the pulleys 538 and 535 when the wing deck 520 is raised above 30 degrees and subsequently lowered.

A hinge pin 630 is attached to the wing deck 520 used to attach the wing to the main deck 500 allowing the wing to rotated up and down around the hinge 570. Removing the wing belt 531 effectively detaches the wing deck 520 from the main deck 500 making it easy to remove the wing deck by sliding it straight back.

What is claimed is:

1. An assembly comprising a skirt placed around a blade under a main or wing deck joining a top at angle between 100 and 150 degrees.

2. An assembly comprising a wing belt is tensioned with a pulley on an idler arm with an arm attached used to brake a blade to a stop by contacting the wing belt and pressing it against a pulley, a spring is used to provide tension to the wing belt as a wing deck, a belt guide keeps the wing belt on the pulleys when the wing deck is raised, a hinge pin is attached to the wing deck used to attach the wing deck to a main deck allowing the wing deck to rotated up and down around a hinge, and the wing belt effectively detaches the wing deck from the main deck making it easy to remove the wing deck by sliding it straight back.
